(19) United States
(12) Patent Application Publication
(10) Pub. No.: US 2004/0145764 A1
(43) Pub. Date: Jul. 29, 2004

(54) Image displaying device and image forming device

(75) Inventors: Masahiro Machida, Kanagawa (JP); Katsura Inoue, Kanagawa (JP); Takao Maekawa, Kanagawa (JP); Noriko Seto, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 10/681,377

(22) Filed: Oct. 9, 2003

(30) Foreign Application Priority Data
Jan. 27, 2003 (JP) 2003-017633

(51) Int. Cl. G06F 15/00; G06F 17/00; G09G 5/00

(52) U.S. Cl. 358/1.13; 345/729; 345/716

(57) ABSTRACT

An image displaying device having a thumbnail image displaying function is provided that is good in operationality for aged persons and handicapped persons and is capable of conveniently displaying a desired number of small images, and an image forming device equipped with the image displaying device is also provided. Upon displaying thumbnail images, the number of thumbnail images to be displayed on a liquid crystal display is previously configured for the normal mode and the voice guide mode, and the number of thumbnail images corresponding to the mode is read. The size of the thumbnail images is decided based on the number of thumbnail images read and the size of the thumbnail image display area of the liquid crystal display, and the thumbnail images are then displayed on the display in the number of thumbnail images configured with the size of the thumbnail images thus decided.

### BACKGROUND OF THE INVENTION

1. Field of the Invention

The present invention relates to an image displaying device, and more particularly, it relates to an image displaying device capable of displaying small images, such as thumbnail images.

2. Description of the Related Art

It has been proposed that upon listing images obtained by photographing with a digital camera or images recorded on a photographic film, plural images are displayed at a time as thumbnail images, which are smaller than the original images.

For example, in the technique described in JP-A-2000-341644, it has been proposes that upon listing images obtained by photographing with a digital camera, the images are displayed with plural image sizes, and the full size image is displayed on a prescribed operation.

In the technique described in JP-A-2002-175143, it has been proposed that in a personal computer or the like, all the pages produced are listed as thumbnail images on a thumbnail screen, and after selecting plural thumbnail images therefrom, the selected thumbnail images are further displayed on a thumbnail screen.

Furthermore, in the technique described in JP-A-10-65901, the number of images to be input is counted, and the images are displayed after configuring the size and the arrangement of thumbnail images corresponding to the number of images thus counted.

It has been called for urgent attention, associated with the forthcoming aging society, to enhance office environments as social infrastructure where aged persons and handicapped persons can work equivalently to the robust, and various proposals have been made (for example, in JP-A-11-122409).

However, there is a problem in the case where the aforementioned thumbnail image displaying function is applied to an image displaying device of an image forming device, such as a duplicator, a printer or a facsimile, which has a small display screen, in that a large number of thumbnail images with a smaller size than that of the original images are displayed, and therefore, aged persons and handicapped persons are difficult to recognize the respective thumbnail images.

Furthermore, there is also another problem in that plural thumbnail images are displayed at a time on one screen since the number of thumbnail images that are displayed on one screen cannot be arbitrarily configured, and therefore, aged persons and handicapped persons are difficult to select a desired image from the screen.

### SUMMARY OF THE INVENTION

The invention has been made in view of the aforementioned circumstances and is to provide such an image displaying device having a thumbnail image displaying function that is good in operationality for aged persons and handicapped persons and is capable of conveniently displaying a desired number of small images, and an image forming device equipped with the image displaying device.

In an aspect of the invention, an image displaying device capable of displaying an image with a small image smaller than the original image contains: a configuring unit for configuring a number of the small image to be displayed on a display screen for displaying the image; a deciding unit for deciding a size of the small image to be displayed on the display screen, based on the number of the small image thus configured by the configuring unit and a size of the display screen; and a controlling and displaying unit for controlling and displaying the small image on the display screen, based on the number of the small image thus configured by the configuring unit and the size of the small image thus decided by the deciding unit.

According to the aforementioned aspect of the invention, in the configuring unit, the number of the small image that is smaller than the original image and is to be displayed on the display screen is configured, and in the deciding unit, the size of the small image to be displayed on the display screen is decided based on the number of the small image configured by the configuring unit and the size of the display screen. For example, the size of the small image is decided in such a manner that the small images in the number thus configured by the configuring unit are properly displayed on the display screen.

In the controlling and displaying unit, the small images having the image size thus decided by the deciding unit are controlled and displayed on the display screen in the number thus configured by the configuring unit.

Accordingly, upon only configuring the number of the small images to be displayed on the display screen, such an image size is automatically decided that the configured number of images can be displayed, and the images are displayed. Therefore, a desired number of small images can be conveniently displayed on a display screen.

In other words, aged persons and handicapped persons can display small images in a desired number only by configuring the number of small images to be displayed in the configuring unit. In the case where the small image thus displayed is difficult to be recognized, the number of the small images to be displayed is reconfigured to a smaller number, whereby the size of the small image can be enlarged to a larger size capable of being displayed on the display screen. Therefore, the size of the small image can be easily changed.

Consequently, such an image displaying device having a thumbnail image displaying function can be provided that is good in operationality for aged persons and handicapped persons and is capable of conveniently displaying a desired number of small images.

In another aspect of the invention, an image forming device contains the aforementioned image displaying device.

According to the aforementioned aspect of the invention, the image displaying device can be applied to an image displaying device, such as a liquid crystal displaying device, provided in an image forming device.

Accordingly, even in an image displaying device with a small display screen applied to an image forming device, the number of small images to be displayed is configured corresponding to the size of the display screen by the configuring unit, whereby aged persons and handicapped persons can easily recognize a small image in the aforementioned manner.

### BRIEF DESCRIPTION OF THE DRAWINGS

Preferred embodiments of the present invention will be described in detail based on the following figures, wherein:

FIG. 1 is a perspective view showing an appearance of a multifunction machine relating to an embodiment of the invention;

FIG. 2 is a diagram showing a specific constitutional example of a control panel;

FIG. 3 is a block diagram showing a constitution of a controlling part of a multifunction machine relating to an embodiment of the invention;

FIG. 4 is a diagram showing an example of a screen for configuring a number of thumbnail images to be displayed;

FIG. 5 is a flow chart showing a process for displaying thumbnail images in a multifunction machine relating to an embodiment of the invention;

FIGS. 6A and 6B are diagrams showing examples of display of thumbnail images;

FIG. 7 is a diagram showing an example of a screen for configuring a number of thumbnail images to be displayed in a modified embodiment;

FIG. 8 is a flow chart showing a process for displaying thumbnail images in a modified embodiment; and

FIGS. 9A and 9B are diagrams showing other examples of display of thumbnail images.

### DESCRIPTION OF PREFERRED EMBODIMENTS

An embodiment of the invention will be described below in detail with reference to the drawings. In the embodiment, the invention is applied to a multifunction machine having the multiple functions, such as a scanner function, a duplicator function, a facsimile function and a printer function.

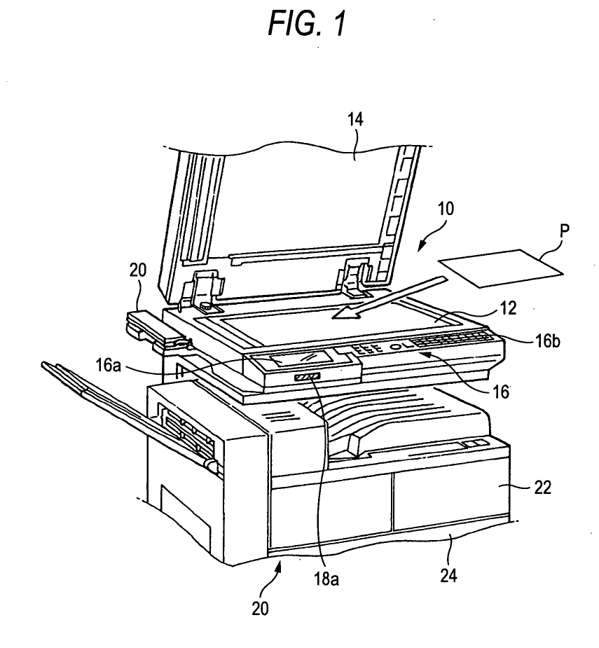

As shown in FIG. 1, an image input part 10 of a multifunction machine according to an embodiment of the invention has a platen glass 12, a cover 14, a control panel 16 and a handset 20. The platen glass 12 is to carry an original copy P for duplication or facsimile. The original copy P carried on the platen glass 12 is read by an image reading device, which is not shown in the figure, and image data of the original copy P thus read is temporarily stored in a memory and subsequently converted to an image signal for facsimile communication or printer output.

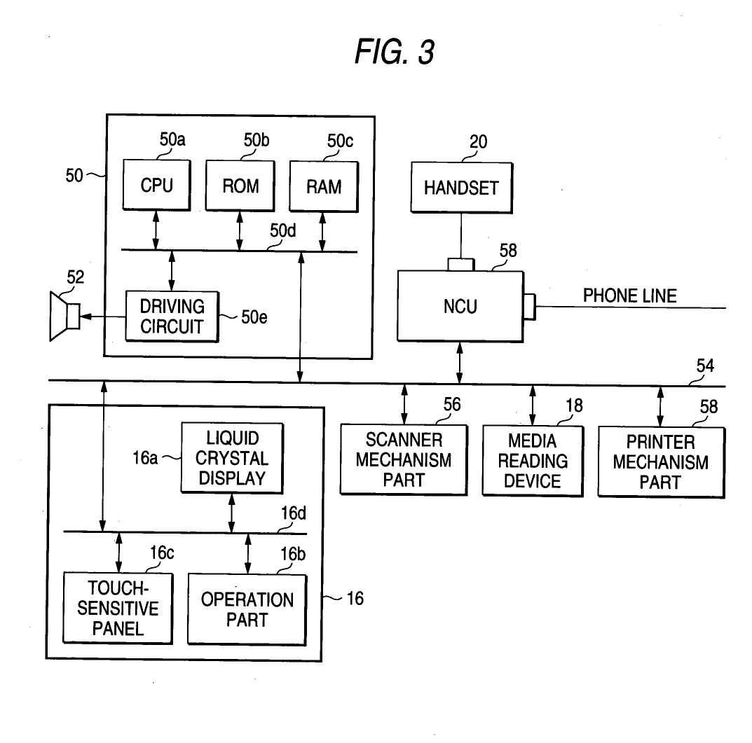

The control panel 16 has a liquid crystal display 16a having a touch-sensitive panel 16c (see FIG. 3) on the surface thereof, and an operation part 16b. The liquid crystal display 16a is used for displaying an operation guide and for displaying various kinds of configuration data upon using the multifunction machine as a duplicator, a facsimile or a printer, and various kinds of configurations can be input by utilizing the touch-sensitive panel 16c. The operation part 16b has various operation buttons, such as a numeric keypad for inputting a number of duplication and facsimile phone numbers, one-touch operation buttons, in which facsimile numbers are registered, and a start button for starting duplication or facsimile communication.

The handset 20 is used on an operation for manual reception of a facsimile. In the image output part 10, an upper part 22 there of has incorporated there in a printer engine for printing image data thus read on the image input part 10, facsimile data sent from another facsimile machine, or character data or image data sent from a personal computer, and a lower part 24 thereof contains paper trays housing paper of various sizes.

A media insertion part 18a of a media reading device 18 (see FIG. 3) for reading various media described later is provided in the vicinity of the liquid crystal display 16a, and images and the like recorded in the media can be printed or sent to an external machine by inserting the media into the media insertion part 18a.

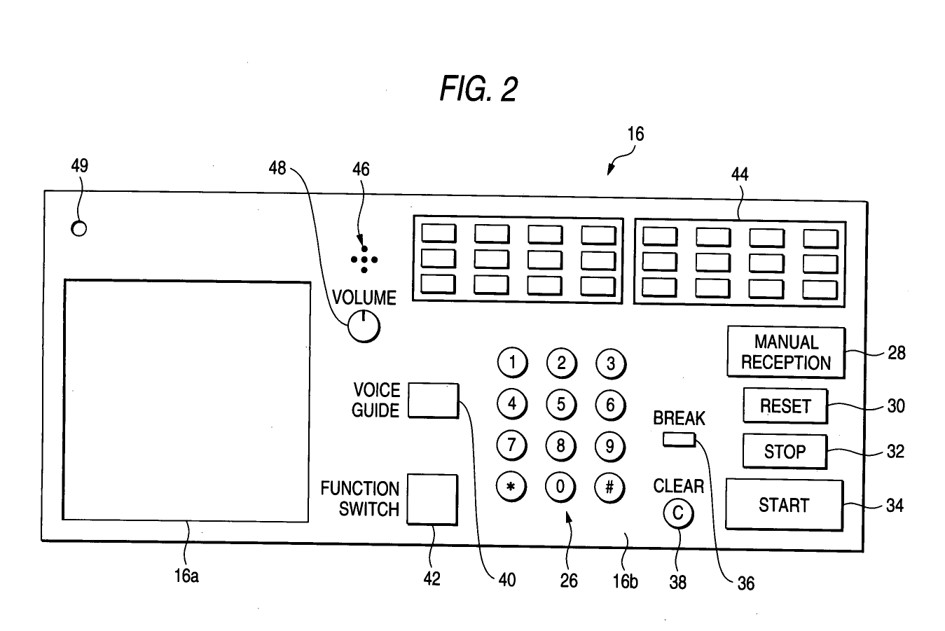

FIG. 2 is a diagram showing a specific example of the constitution of the control panel 16. In the control panel 16, the liquid crystal display 16a is arranged on the left side, and the operation part 16b is arranged on the right side. In the operation part 16b, a numeric keypad 26, a manual reception button 28, a reset button 30, a stop button 32, a start button 34, a break button 36, a clear button 38, a voice guide button 40, a function switch button 42 and one-touch operation buttons 44 are provided. A voice output part 46, a volume knob 48 and an earphone jack 49 are also provided in the operation part 16b.

The numeric keypad 26 is used for configuring the number of sheets of copies or the number of copies, and inputting a telephone number for facsimile, and registering telephone numbers to the one-touch operation buttons 44. The manual reception button 28 is used for switching the automatic reception mode of facsimile to the manual reception mode. The reset button 30 is used for canceling the inputted value in the case where the value is wrong. The stop button 32 is used for stopping the operation having been started.

The start button 34 is used for starting the operation, such as duplication, facsimile or printer, after completing configuration. The break button 36 is used for interrupting the operation. The clear button 38 is used for clearing the configuration set through the control panel 16 to retrieve the initial configuration.

The voice guide button 40 is used for carrying out all the operations in a voice guide mode. The voice in the voice guide mode is output from the voice output part 46 and can be listened with an earphone by inserting it into the earphone jack 49. The volume of the voice can be adjusted with the volume knob 48. In the case where the voice guide button 40 is pressed upon occurring trouble, explanation of the trouble is output by voice.

The function switch button 42 is a button for switching the mode of the multifunction machine to a duplicator, a facsimile or a printer. The one-touch operation buttons 44 are used for calling the telephone numbers having been registered therein only by pressing the buttons.

The constitution of the controlling part having the control panel 16 of the multifunction machine will be described. FIG. 3 is a block diagram showing the constitution of the controlling part of the multifunction machine.

The multifunction machine has a main controller 50, and the main controller 50 is constituted with a microcomputer having a CPU 50a, a ROM 50b and a RAM 50c connected to a bus 50d. The ROM50b contains voice guide data, and data and programs for displaying on the liquid crystal display 16a. A driving circuit 50e for driving a speaker 52 for voice output of the voice guide and error messages is connected to the bus 50d of the main controller 50. The voice from the speaker 52 is output to the exterior through the voice output part 46 of the control panel 16 shown in FIG. 2.

The RAM 50c has a box function represented by a confidential box, in which information, such as image information, input from an external device is stored.

The control panel 16, a scannermechanismpart 56, a printer mechanism part 58 and an NCU (network control unit) 58 are connected to the main controller 50 through a system bus 54. The control panel 16 receives image data for displaying operation guide from the main controller 50 and displays the image data on the liquid crystal display 16a, and also it receives input from the buttons on the operation part 16b, such as the voice guide button 40, and sends the input information to the main controller 50.

The scanner mechanism part 56 receives a reading operation instruction from the main controller 50 to carry out the reading operation of an original copy and sends the image data thus read to the main controller 50 through the system bus 54.

The printer mechanism part 58 prints printing data sent from the main controller 50. The main controller 50 receives signals from sensors provided in the scanner mechanism part 56 and the printer mechanism part 58 to monitor the operating state of the scanner mechanism part 56 and the printer mechanism part 58.

In the case where the multifunction machine is used as a facsimile machine, the NCU 58 connects a phone line to the main controller 50, and upon off hooking the handset 20, the NCU 58 connects the phone line to the handset 20. The NCU 58 is connected to a network line, which is not shown in the figure, and the NCU 58 receives data sent from a personal computer connected to the network line and sends the data to the main controller 50.

In the control panel 16, the liquid crystal display 16a, a touch-sensitive panel 16c provided corresponding to the display of the liquid crystal display 16a, and an operation part 16b are connected to a system bus 16d, whereby display on the liquid crystal display 16a is attained through control by the main controller 50, and operations input on the touch-sensitive panel 16c and the operation part 16b are sent to the main controller 50.

A media reading device 18 is connected to the system bus 54, and is constituted in such a manner that information on various kinds of media can be read. Examples of the media that can be applied include a flexible disk, a CD-ROM, a DVD, Smart Media (trade name), a memory card and the like.

The thumbnail image displaying function appearing on the liquid crystal display 16a in the multifunction machine of this embodiment of the invention will be described.

The multifunction machine of this embodiment has such a function in that an image input from an external device or various kinds of media is displayed as a thumbnail image, which is smaller than the original image, and for example, information stored by the box function of the RAM 50c, an image stored in the various media, which contain image data obtained by picturing with a digital camera, and an image red by the scanner mechanism part 56 can be printed or sent by an e-mail, upon which plural images to be printed or sent by an e-mail can be displayed as thumbnail images, which are smaller than the original images.

The number of the thumbnail images to be displayed on the liquid crystal display 16a can be configured. The number of the thumbnail images to be displayed is configured in a predetermined screen for configuring the number of thumbnail images to be displayed, and the size of the thumbnail images to be displayed on the liquid crystal display 16a is decided based on the number of thumbnail images thus configured and the size of the effective display area of the liquid crystal display 16a, whereby thumbnail images are displayed in the number of thumbnail images thus configured and the size of thumbnail images thus decided.

In the multifunction machine of this embodiment, furthermore, different numbers of thumbnail images to be displayed can be configured in the voice guide mode switched by the voice guide button 40 and in the normal mode other than the voice guide mode. For example, the voice guide mode is considered as a handicapped mode used by aged persons and handicapped persons, and it is possible in the voice guide mode that thumbnail images are displayed in a smaller number with a larger size than the normal mode. That is, the image displaying device according to the invention may further contain a selecting unit, such as the voice guide button 40, for selecting two or more modes, among which the numbers of thumbnail images to be displayed are different from each other.

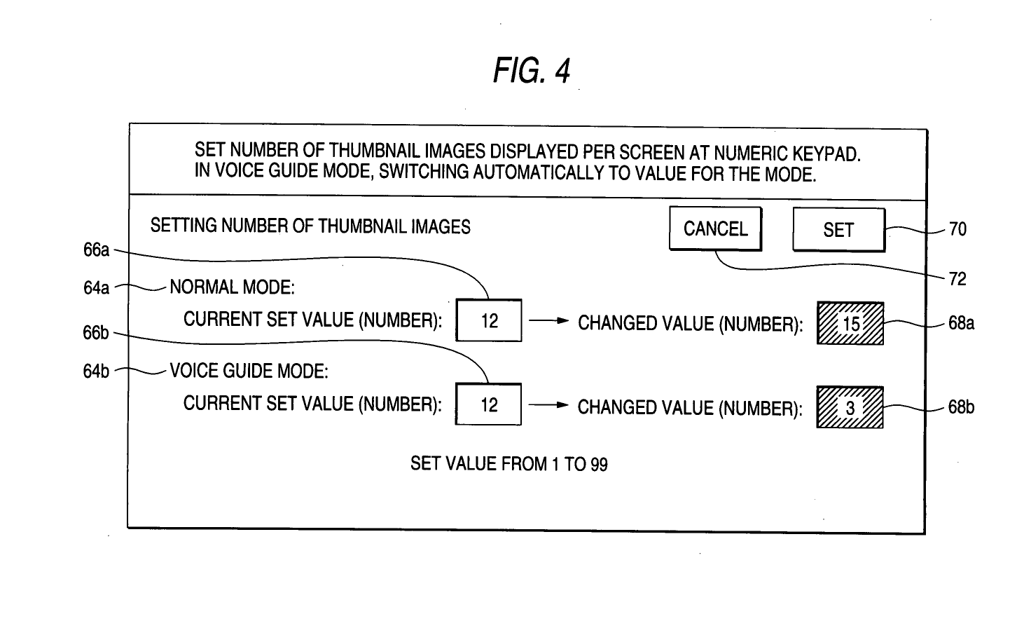

FIG. 4 shows an example of a screen for configuring the number of thumbnail images to be displayed. As shown in FIG. 4, changed values 68a and 68b for the normal mode and the voice guide mode can be configured by operating a numeric keypad 26 with reference to current values 66a and 66b, and the mode for configuring the number of thumbnail images to be displayed is selected with mode buttons (the normal mode 64a and the voice guide mode 64b) displayed on the liquid crystal display 16a by operating the touch-sensitive panel of the liquid crystal display 16a. The desired number of thumbnail images is configured by operating the numeric keypad 26, and the number of thumbnail images thus configured can be set with a set button 70 or cancelled with a cancel button 72. The number of thumbnail images thus set is stored in the RAM 50c of the main controller 50 and renewed on every setting operations.

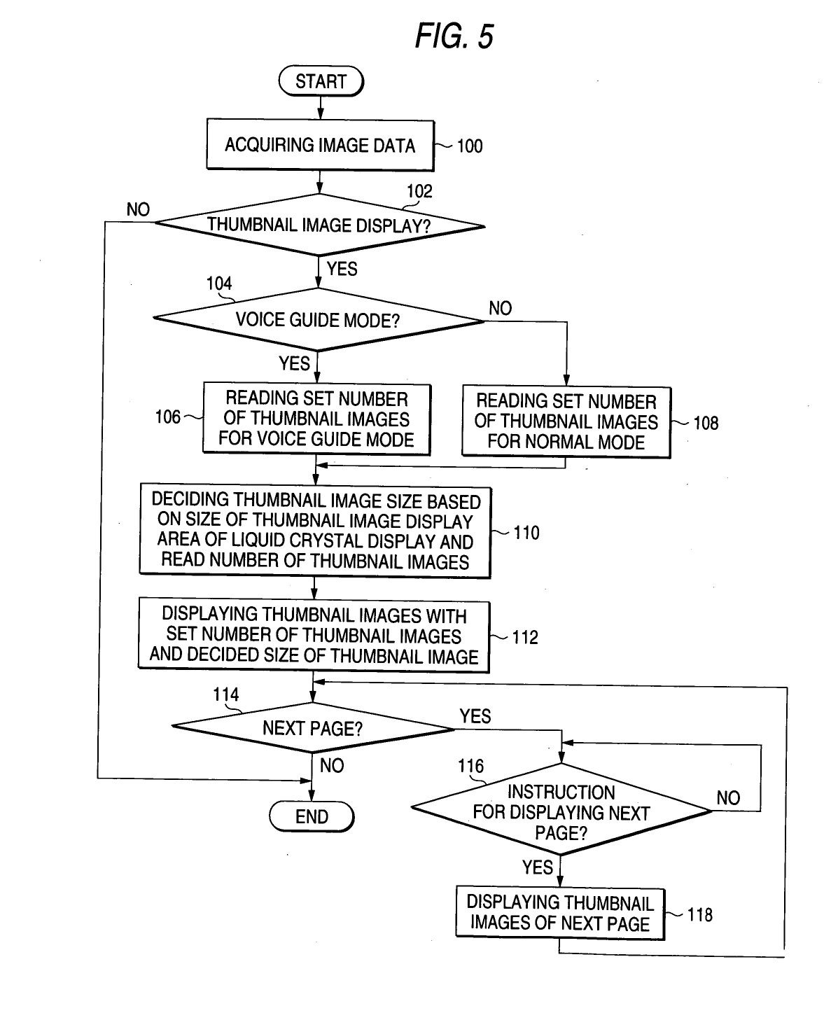

A process for displaying thumbnail images in the multifunction machine constituted as in the foregoing will be now described with reference to the flow chart shown in FIG. 5, in which thumbnail images are displayed based on the number of thumbnail images set on the screen for configuring the number of thumbnail images to be displayed.

In step 100, image data is acquired. As the image data, for example, image data sent from an external personal computer, image data read from a medium with the media reading device 18, or image data obtained by reading an original copy with the scanner mechanism part 56 is acquired.

In step 102, it is decided as to whether or not thumbnail images are to be displayed. The decision is made by the presence of an instruction for displaying thumbnail images made through the operation part 16b or the touch-sensitive panel 16c, and in the case where the decision is denied, the process for displaying thumbnail images is terminated. In the case where the decision in the step 102 is affirmed, step 104 is then executed.

In the step 104, it is decided as to whether or not the voice guide mode is selected. The decision is made as to whether or not the voice guide button 40 has been pressed to select the voice guide mode. In the case where the decision is affirmed, step 106 is executed to read the number of thumbnail images to be displayed for the voice guide mode thus set in the screen for configuring the number of thumbnail images to be displayed, and then step 110 is executed. In the case where the decision in the step 104 is denied, step 108 is executed to read the number of thumbnail images to be displayed for the normal mode thus set in the screen for configuring the number of thumbnail images to be displayed, and then step 110 is executed.

In the step 110, the size of the thumbnail images is decided based on the size of the thumbnail image display area of the liquid crystal display 16a and the number of thumbnail images to be displayed thus read. That is, the size of the thumbnail images is decided according to the thus-read number of thumbnail images to be displayed and in accordance with the size of the area of liquid crystal display, and then step 112 is executed.

In the step 112, thumbnail images are displayed on the liquid crystal display 16a in the number of thumbnail images having been set on the screen for configuring the number of thumbnail images with the size of the thumbnail images decided in the step 110.

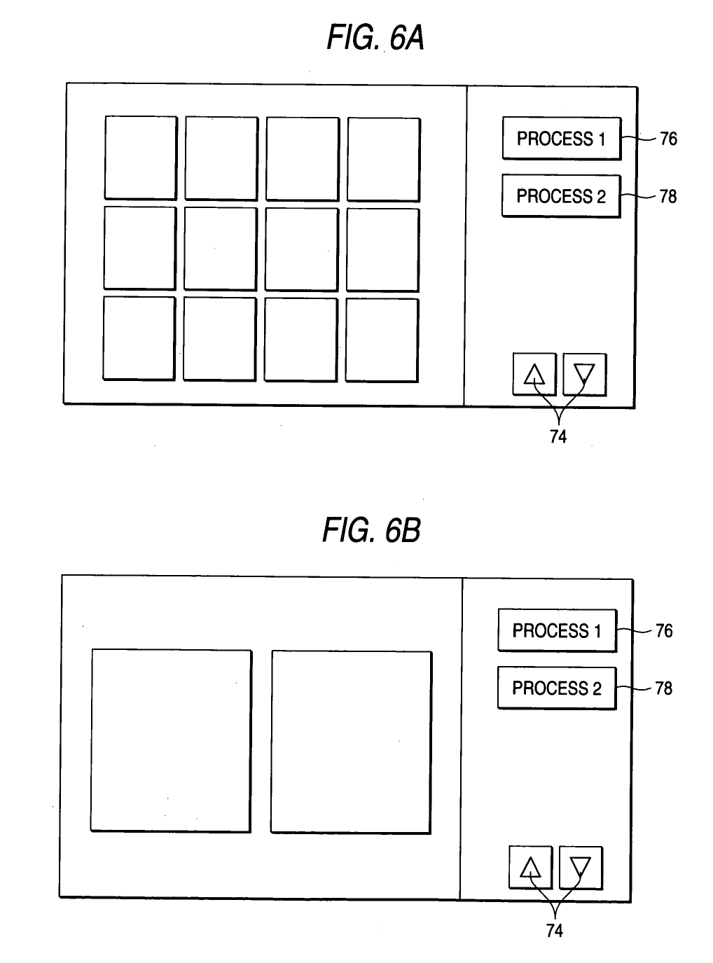

For example, in the case of the normal mode, thumbnail images are displayed in the manner shown in FIG. 6A, and in the case of the voice guide mode, thumbnail images are displayed in the manner shown in FIG. 6B. In this example, the number of thumbnail images is set to 12 in the normal mode shown in FIG. 6A, and the number of thumbnail images is set to 2 in the voice guide mode shown in FIG. 6B.

Subsequently, the presence of the next page is determined in step 114. That is, it is decided as to whether or not there is another image among the images acquired in the step 100 remaining after the thumbnail images currently displayed, and in the case where the decision is affirmed, step 116 is then executed.

In the step 116, it is decided as to whether or not an instruction for displaying the next page is made. The decision is made as to whether or not the position of the touch-sensitive panel 16c corresponding to a next page button 74 or the like displayed on the liquid crystal display 16a is operated as shown in FIGS. 6A and 6B. In the case where the decision is denied, the process is suspended until the decision is affirmed, and when the decision is affirmed, step 118 is then executed to display thumbnail images for the next page.

During the period where the thumbnail images are displayed in the step 112, or during the period where the process is suspended for awaiting the decision in the step 116, in the case where the positions on the touch-sensitive panel 16c corresponding to the buttons for executing the predetermined operations, such as a process 1 button 76 and a process 2 button 78 displayed on the liquid crystal display 16a shown in FIGS. 6A and 6B, are operated, the corresponding operations may be executed.

In the case where the decision in the step 114 is denied, the process for displaying thumbnail images is then terminated.

The steps 104 to 108 correspond to the configuring unit in the invention, the step 110 corresponds to the deciding unit of the invention, and the step 112 corresponds to the controlling unit of the invention.

As described in the foregoing, in the multifunction machine of this embodiment according to the invention, the number of thumbnail images to be displayed on the liquid crystal display 16a is previously configured on the screen for configuring the number of thumbnail images to be displayed as shown in FIG. 4, and the thumbnail images can be displayed corresponding to the configuration, whereby the desired number of thumbnail images can be displayed on the liquid crystal display 16a. At this time, the size of the thumbnail images thus displayed is decided based on the number of the thumbnail images thus configured and the size of the display area of the liquid crystal display 16a. Accordingly, thumbnail images with a larger size can be displayed by configuring the number of thumbnail images to a smaller value in comparison to the case where the number of thumbnail images is configured to a larger value, whereby. such thumbnail images can be conveniently displayed that are easily recognized by aged persons and handicapped persons. In this embodiment, furthermore, in the voice guide mode used by aged persons and handicapped persons, the thumbnail images are displayed in the number of thumbnail images for the voice guide mode, whereby aged persons and handicapped persons can obtain such display of thumbnail images that can be easily recognized only by selecting the voice guide mode.

The number of thumbnail images to be displayed can be conveniently configured on the screen for configuring the number of thumbnail image, and therefore, the configuration can be changed depending on preference of a user, so as to provide good operationality.

Subsequently, a modified embodiment of the embodiment of the invention will be described.

In the aforementioned embodiment, different numbers of thumbnail images to be displayed are set in the voice guide mode and the normal mode, and the thumbnail images are displayed in the numbers for the respective modes. In the modified embodiment, thumbnail images are simply displayed in a number having been configured. Since the constitutions of the devices are the same as in the aforementioned embodiment, description therefor is omitted herein.

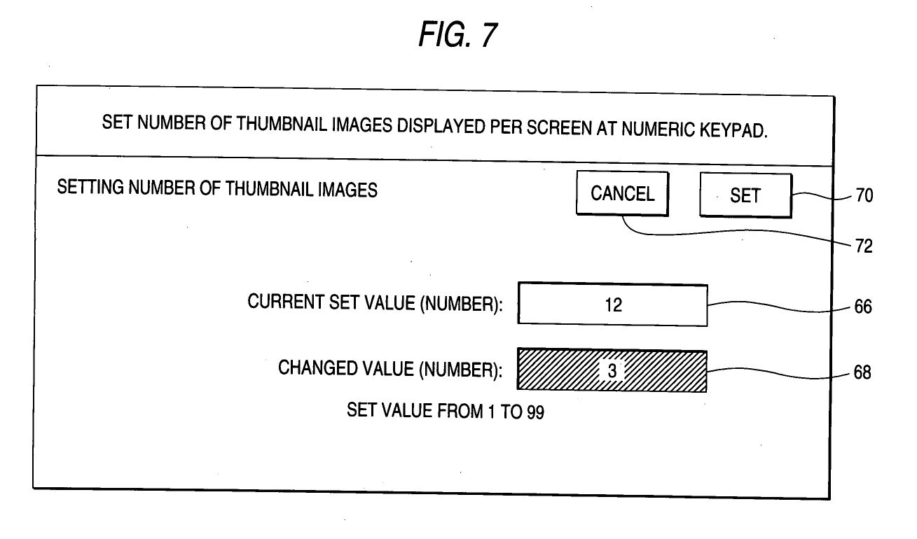

FIG. 7 shows an example of a screen for configuring the number of thumbnail images to be displayed in the modified embodiment. As shown in FIG. 7, a changed value 68 can be configured by operating a numeric keypad 26 with reference to current value 66. The desired number of thumbnail images is configured by operating the numeric keypad 26, and the number of thumbnail images thus configured can be set with a set button 70 or cancelled with a cancel button 72. The number of thumbnail images thus set is stored in the RAM 50c of the main controller 50 and renewed on every setting operations.

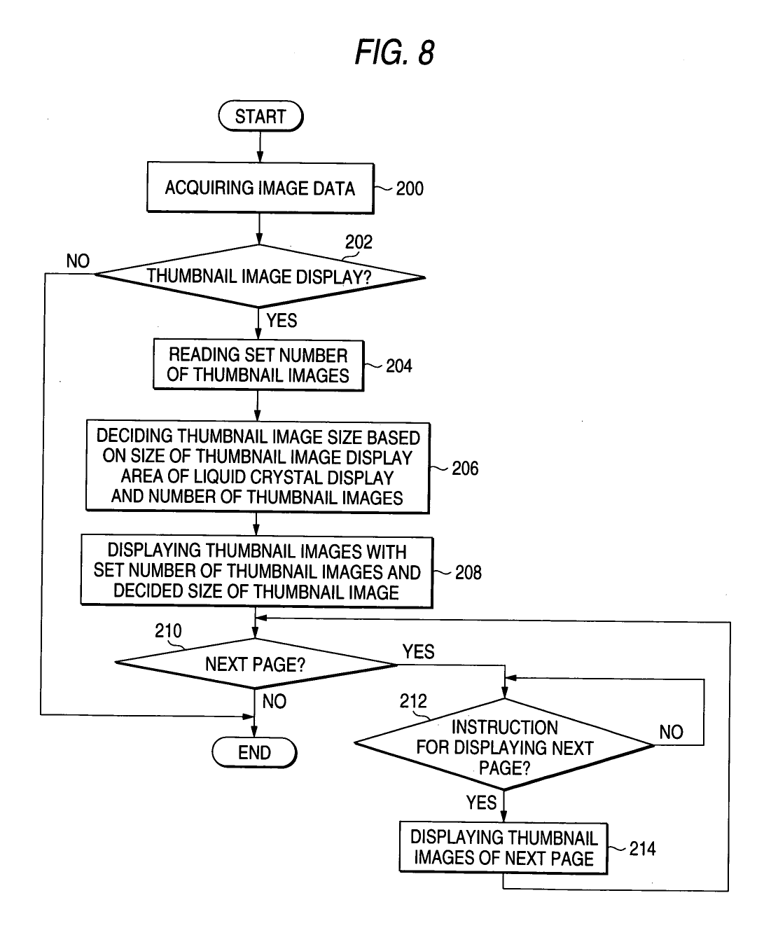

A process for displaying thumbnail images in the modified embodiment will be now described with reference to the flow chart shown in FIG. 8, in which thumbnail images are displayed based on the number of thumbnail images set on the screen for configuring the number of thumbnail images to be displayed.

In step 200, image data is acquired. As the image data, for example, image data sent from an external personal computer, image data read from a medium with the media reading device 18, or image data obtained by reading an original copy with the scanner mechanism part 56 is acquired.

In step 202, it is decided as to whether or not thumbnail images are to be displayed. The decision is made by the presence of an instruction for displaying thumbnail images made through the operation part 16b or the touch-sensitive panel 16c, and in the case where the decision is denied, the process for displaying thumbnail images is terminated. In the case where the decision in the step 202 is affirmed, step 204 is then executed.

In the step 204, the number of thumbnail images to be displayed thus having been set on the screen for configuring the number of thumbnail images is read, and then step 206 is executed.

In the step 206, the size of the thumbnail images is decided based on the size of the thumbnail image display area of the liquid crystal display 16a and the number of thumbnail images to be displayed thus read. That is, the size of the thumbnail images is decided according to the thus-read number of thumbnail images to be displayed and in accordance with the size of the area of liquid crystal display, and then step 208 is executed.

In the step 208, thumbnail images are displayed on the liquid crystal display 16a in the number of thumbnail images having been set on the screen for configuring the number of thumbnail images with the size of the thumbnail images decided in the step 206.

Thumbnail images are displayed corresponding to the number thus set on the screen for configuring the number of thumbnail images to be displayed as shown in FIGS. 6A and 6B described for the aforementioned embodiment. In the aforementioned embodiment, the example of thumbnail images displayed as shown in FIG. 6A is for the normal mode, and the example of thumbnail images displayed as shown in FIG. 6B is for the voice guide mode. In this modified embodiment, on the other hand, the figures are described on such assumption that the example shown in FIG. 6A is the case where the number of thumbnail images to be displayed is set to 12, and the example shown in FIG. 6B is the case where the number of thumbnail images to be displayed is set to 2.

Subsequently, the presence of the next page is determined in step 210. That is, it is decided as to whether or not there is another image among the images acquired in the step 200 remaining after the thumbnail images currently displayed, and in the case where the decision is affirmed, step 212 is then executed.

In the step 212, it is decided as to whether or not an instruction for displaying the next page is made. The decision is made as to whether or not the position of the touch-sensitive panel 16c corresponding to a next page button 74 or the like displayed on the liquid crystal display 16a is operated as shown in FIGS. 16A and 16B. In the case where the decision is denied, the process is suspended until the decision is affirmed, and when the decision is affirmed, step 214 is then executed to display thumbnail images for the next page.

During the period where the thumbnail images are displayed in the step 208, or during the period where the process is suspended for awaiting the decision in the step 212, in the case where the positions on the touch-sensitive panel 16c corresponding to the buttons for executing the predetermined operations, such as a process 1 button 76 and a process 2 button 78 displayed on the liquid crystal display 16a shown in FIGS. 6A and 6B, are operated, the corresponding operations may be executed.

In the case where the decision in the step 210 is denied, the process for displaying thumbnail images is then terminated.

As described in the foregoing, in the multifunction machine of the modified embodiment, the number of thumbnail images to be displayed on the liquid crystal display 16a is previously configured on the screen for configuring the number of thumbnail images to be displayed as shown in FIG. 7, and the thumbnail images can be displayed corresponding to the configuration, whereby the desired number of thumbnail images can be displayed on the liquid crystal display 16a. At this time, the size of the thumbnail images thus displayed is decided based on the number of the thumbnail images thus configured and the size of the display area of the liquid crystal display 16a. Accordingly, thumbnail images with a larger size can be displayed by configuring the number of thumbnail images to a smaller value in comparison to the case where the number of thumbnail images is configured to a larger value, whereby such thumbnail images can be conveniently displayed that are easily recognized by aged persons and handicapped persons.

The number of thumbnail images to be displayed can be conveniently configured on the screen for configuring the number of thumbnail image, and therefore, the configuration can be changed depending on preference of a user, so as to provide good operationality.

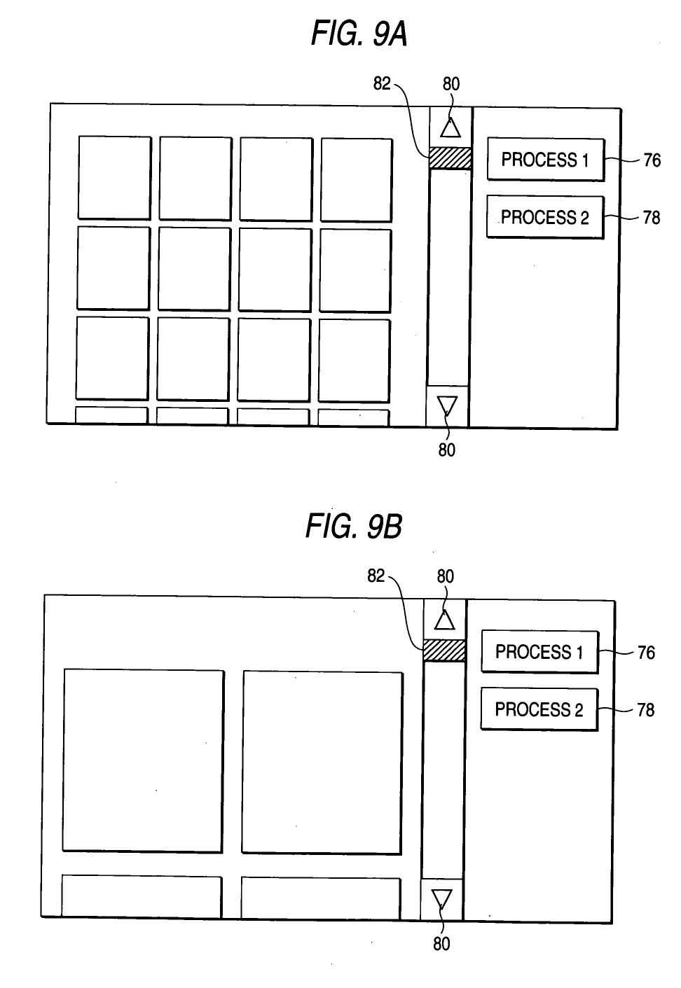

In the aforementioned embodiment and the modified embodiment, the next page, if it is present, upon displaying the thumbnail images is displayed by operating the next page button 74, but the invention is not limited to these embodiments. For example, it is possible that scrolling buttons 80 are displayed instead of the next page button 74, and in the case where the position of the touch-sensitive panel 16c corresponding to the scrolling button 80 is operated, the screen is scrolled in the direction corresponding to the operation to display remaining thumbnail images having not been displayed as shown in FIG. 9A and FIG. 9B. In this case, a scroll bar 82 may also be provided to show the approximate position of the thumbnail images currently displayed among the total thumbnail images to be displayed. The screen may also be scrolled by moving the scroll bar 82.

In the aforementioned embodiments, upon configuring the number of thumbnail images to be displayed, the number of thumbnail images to be displayed on the liquid crystal display 16a is directly configured, but the number of thumbnail images arranged in at least one of the axial direction and the lateral direction of the liquid crystal display 16a may be configured. That is, in the example shown in FIG. 6A, it is possible that the number of thumbnail images is configured to 3 in the axial direction or 4 in the lateral direction to attain the display configuration shown in FIG. 6A, or in alternative, both the numbers of thumbnail images arranged in the axial and lateral directions may be respectively configured.

As described in the foregoing, according to the invention, the number of small images to be displayed on the display screen can be configured, and the size of the small images can be changed only with the configuration of the number of the small images. Therefore, the invention exerts such an effect that a thumbnail image displaying function is provided that is good in operationality for aged persons and handicapped persons.

The entire disclosure of Japanese Patent Application No. 2003-017633 filed on Jan. 27, 2003 including specification, claims, drawings and abstract is incorporated herein by reference in its entirety.

What is claimed is:

1. An image displaying device capable of displaying an small image smaller than an original image comprising:
a configuring unit for configuring a number of the small image to be displayed on a display screen for displaying the image;
a deciding unit for deciding a size of the small image to be displayed on the display screen, based on the number of the small image configured by the configuring unit and a size of the display screen; and
a controlling and displaying unit for controlling and displaying the small image on the display screen, based on the number of the small image configured by the configuring unit and the size of the small image decided by the deciding unit.

2. The image displaying device as claimed in claim 1, wherein the image displaying device has two or more modes having numbers of the small image configured by the configuring unit, the modes being different from each other, and the image displaying device further comprises a selecting unit for selecting the modes.

3. The image displaying device as claimed in claim 2, wherein the modes comprise a mode specialized for aged persons and handicapped persons.

4. The image displaying device as claimed in claim 1, wherein the configuring unit configures the number of the small image arranged at least one of an axial direction and a lateral direction on the display screen.

5. An image forming device comprising:
an image displaying device capable of displaying an small image smaller than an original image, the image forming device comprising:
a configuring unit for configuring a number of the small image to be displayed on a display screen for displaying the image;
a deciding unit for deciding a size of the small image to be displayed on the display screen, based on the number of the small image configured by the configuring unit and a size of the display screen; and
a controlling and displaying unit for controlling and displaying the small image on the display screen, based on the number of the small image configured by the configuring unit and the size of the small image decided by the deciding unit.

6. An image displaying apparatus for displaying a plurality of thumbnail images on a screen comprising:
a selector for selecting a handicapped mode or a normal mode;
a controller for making the lager size of the thumbnail image on the screen , of which size being larger than the size of the thumbnail image at the normal mode, when the selector selects the handicapped mode; and
a display for displaying the larger size of the thumbnail images made by the controller.

7. The image displaying apparatus as claimed in claim 6, wherein the selector further comprises a detector for detecting a voice guide mode being operated.

8. The image displaying apparatus as claimed in claim 6, further comprising:
a configuring unit for configuring a number of the thumbnail images to be displayed on the screen; and
a deciding unit for deciding a size of the thumbnail image to be displayed on the screen, based on the number of the thumbnail images configured by the configuring unit;
wherein the controller makes the larger size of the thumbnail image based on the deciding unit.

9. An image displaying method capable of displaying an small image smaller than an original image comprising:
configuring step for configuring a number of the small image to be displayed on a display screen for displaying the image;
deciding step for deciding a size of the small image to be displayed on the display screen, based on the number of the small image configured by the configuring unit and a size of the display screen; and
displaying step for displaying the small image on the display screen, based on the number of the small image configured by the configuring step and the size of the small image decided by the deciding step.

10. The image displaying method as claimed in claim 9, further comprising selecting step for selecting modes having numbers of the small image configured by the configuring step, the modes being different from each other.

11. The image displaying method as claimed in claim 10, wherein the selecting step selects the mode being specialized for aged persons and handicapped persons.

12. The image displaying method as claimed in claim 11, wherein the configuring step configures a number of the small image arranged at least one of an axial direction and a lateral direction on the display screen.
